(19) United States
(12) Patent Application Publication
(10) Pub. No.: US 2009/0198159 A1
(43) Pub. Date: Aug. 6, 2009

(54) Friction Tool For Use In A Cosmetic Method

(75) Inventor: Geoffrey Robert Linzell, Hatfield (GB)

Correspondence Address: FOX ROTHSCHILD LLP, 2000 MARKET STREET, 10th Floor, PHILADELPHIA, PA, 19103, US

(73) Assignee: Ball Burnishing Machine Tools Ltd., Hatfield (GB)

(21) Appl. No.: 12/302,371

(22) PCT Filed: May 25, 2007
(86) PCT No.: PCT/GB2007/001960

§ 371 Date: Nov. 25, 2008

(30) Foreign Application Priority Data
May 25, 2006 (GB) 0610373.3
Oct. 5, 2006 (GB) 0619635.6
Feb. 6, 2007 (GB) 0702194.2

(51) Int. Cl. A61H 7/00

(52) U.S. Cl. 601/138

(57) ABSTRACT

There is provided a friction tool for use in a cosmetic method for the treatment of mammalian skin. The tool comprises a body (60) defining a support having a planar support face; a friction pad (65) provided to said support face, said friction pad defining a friction face. The friction pad comprises a lofty non-woven fibre material or both a compressible foam layer and a layer of friction-enhancing material defining said friction face. A cosmetic method, which can be performed using the tool is also described.

### FIELD OF THE INVENTION

There is described a friction tool for use in a cosmetic method for application to mammalian skin. There is also described the cosmetic method.

### BACKGROUND TO THE INVENTION

To improve cosmetic appearance and for personal care purposes it is known to accelerate removal of flaking skin by exfoliating with mild abrasives by rubbing. It is therefore known to rub the skin with abrasive materials and tools capable of developing aggressive friction at the surface of the skin. In one example, a loofah is used as the tool, wherein a loofah is a bundle of natural or synthetic fibres that is used to exfoliate during bathing by rubbing to remove dead skin. To avoid discomfort such exfoliation is often done with fluids that lubricate the interface and moderate skin damage caused by the abrasion.

In an extreme variant, cosmetic surgeons use the term excoriation to describe a method where significant amounts of the epidermal layer is removed and this is usually done with abrasives by rubbing or scraping with a sharp instrument, which causes severe discomfort and is usually done under anaesthetic.

Massage techniques are also known. Massage may generally be described as the practice of applying structured pressure, tension, motion or vibration, manually or with mechanical aids, to the soft tissues of the body, including muscles, connective tissue, tendons, ligaments, and joints, to achieve a beneficial response. Massage can be performed with hands, feet, elbows and a variety of shaped tools.

The term ‘friction massage’ is used to describe some massage treatments. The purpose of ‘friction massage’ is however, not to treat the surface layers of the skin, but rather to treat deep tissues attached to skeletal members. It is often performed through a layer of clothing to prevent friction damage to skin. However, where performed directly the skin is generally lubricated to reduce actual skin friction during massage. Thus, it is a primary objective in ‘friction massage’ to minimise friction at the skin.

Skin cleansing techniques are also known in which a pad supported by the user's hand or finger or alternatively, on a tool is brought into rubbing contact with the skin. PCT Patent Application No. WO 2006/019507 for example, in the name of Zuko, LLC describes one suitable tool. Such techniques conventionally avoid aggressive frictional contact at the surface of the skin (see paragraph [00067] of '507) to avoid “pulling” of the skin because such pulling can lead to premature wrinkling of the skin.

Applicant has now devised a new kind of cosmetic method and tools suitable for use therein, in which a particular kind of frictional contact is necessarily employed at the skin surface. In the method herein a frictional face of the tool is brought into frictional contact with the outer (i.e. cutaneous) surface layer of the skin to be treated. A degree of downward force is applied, and the frictional face of the tool is moved (e.g. by a stroking movement) in a direction generally parallel to the outer surface layer of the skin such that the outer surface layer of the skin is gripped thereby, and therefore moves with the frictional face of the tool. Any uneven “pulling” of the outer surface layer of the skin is thereby, avoided. Importantly, during such movement one or more underlying (i.e. subcutaneous) layers of the skin are subject to lateral (e.g. shear) stress, which Applicant has found results in desirable “exercise” or “training” of those one or more underlying skin layers, which gives rise to a cosmetic skin appearance benefit.

Applicant has appreciated that the method of the present invention differs from both exfoliation and excoriation techniques because aggressive (i.e. damaging) frictional rubbing contact at the outer layer of the skin is avoided. Rather, in the method of the present invention, that outer layer of skin is gripped by the friction face of the tool, and moves with that friction face.

Applicant has further appreciated that the method of the present invention differs from ‘friction massage’ and ‘skin cleansing’ techniques because these seek to avoid any “pulling” of the skin, whereas Applicant's method deliberately induces lateral stress across the gripped cutaneous layer (the skin), which strains subcutaneous tissue attached thereto.

Thus, in summary, the prior art has been appreciated to disclose tools and methods for exfoliating, excoriating, massaging and/or cleansing cutaneous tissues, but does not disclose or anticipate tools or a method for exercising and training subcutaneous tissues by applying high levels of lateral stress sufficient to strain and distort such tissues then suitably correcting bulk distortion, done in the short time available with an equal and opposite following stroke.

The problem addressed by the claimed invention is therefore to provide a method and tool (apparatus) for use therein that can rapidly apply sufficient lateral stress to exercise the skin evenly down into the subcutaneous tissues, including associated connective tissues and muscles without negatively affecting the skin or the subcutaneous tissue. The problem is solved by use of the method and friction tool described herein. The method herein may in additional aspects, be conducted while applying cosmetic formulations or shaving lubricants to the skin.

Applicant has also found that it is desirable in applying the method herein to avoid high stress transitions at the skin surface such as may occur where in use, an edge of the frictional face of the tool slidingly engages the outer (cutaneous) layer of the skin. In improvements herein, such high stress edge transitions may be essentially avoided by providing ‘soft’ edges to the frictional tool. Additionally, the number of such high stress edge transitions may be reduced by using a frictional face of sufficiently large face area relative to the surface area of skin to be treated.

### SUMMARY OF THE INVENTION

According to one aspect of the present invention there is provided a cosmetic method for the treatment of mammalian skin by a tool defining a friction face, the method comprising:

bringing said friction face of said tool into contact with an outer skin surface of a cutaneous layer of said mammalian skin;

applying a vector force to said tool, the vector force comprising a first vector component and a second vector component, wherein

said first vector component acts normal to said outer skin surface to hold the friction face of the tool in constant frictional contact with a defined area of the outer skin surface and to apply compressive force to one or more subcutaneous layers of the mammalian skin underlying said cutaneous layer; and

the second vector component acts parallel to the outer skin surface surface such as to laterally displace said defined area of the outer skin, thereby applying lateral stress to said one or more subcutaneous layers.

According to another aspect of the present invention there is provided a friction tool for use in a cosmetic method for the treatment of mammalian skin, the tool comprising

a body;

said body defining a support having a planar support face;

a resiliently deformable friction pad provided to said support face,

said friction pad defining a friction face, wherein

the friction pad comprises a lofty non-woven fibre material.

According to another aspect of the present invention there is provided a friction tool for use in a cosmetic method for the treatment of mammalian skin, the tool comprising

a body;

said body defining a support having a planar support face;

a resiliently deformable friction pad provided to said support face,

said friction pad defining a friction face, wherein

the friction pad comprises a compressible foam layer in combination with a layer of friction-enhancing material that defines said friction face.

### DETAILED DESCRIPTION OF THE INVENTION

There is described a cosmetic method for the treatment of mammalian skin and a friction tool for use in performing that cosmetic method.

### Cosmetic Method

The cosmetic method herein is for the treatment of mammalian skin by the use of a tool defining a friction face. The friction face generally defines a flat (i.e. planar—planar meaning ‘relating to or in the form of a plane’) frictional work surface. That friction face is in embodiments, provided by a resiliently deformable friction pad. The friction pad suitably defines a relatively large area of frictional contact. The friction pad suitably has soft edges provided thereto.

The method includes the step of bringing the friction face of the tool into contact with an outer skin surface of a cutaneous layer of the mammalian skin.

The method then includes the step of applying a vector force to the tool. Such force may be applied manually by the user or by a third party (e.g. a beautician treating a client's skin), or in embodiments be provided by mechanical means provided to the tool. The vector force comprises a first vector component and a second vector component.

The first vector component acts normal to the outer skin surface. The effect is firstly to hold the friction face of the tool in constant frictional contact with a defined area of the outer skin surface. Secondly, the effect is to apply compressive force to one or more subcutaneous layers of the mammalian tissue. Those subcutaneous layers underlie and are coupled to the cutaneous layer.

The second vector component acts parallel to the outer skin surface such as to laterally displace said defined area of the outer skin, thereby applying lateral stress to said one or more subcutaneous layers. Suitably, the lateral displacement of the defined area of the outer skin surface is uniform across that defined area.

It has been found that such application of lateral (e.g. shear) stress at the one or more subcutaneous layers results in desirable “exercise” or “training” of those subcutaneous tissue layers by stressing and in some cases beneficially straining said tissues against skeletal anchorages. This gives rise to a cosmetic skin appearance benefit such as improving bodily shape and especially facial shape and the expressive facial features. For example, benefits may include an improved smile with less skin wrinkling, the possible net result being to offset aging effects by approximately five years on faces more than 40 years old!

The friction face of the tool is suitably brought into contact with the outer skin surface such that it follows the profile thereof and makes even frictional contact therewith over a relatively large contact area.

Additionally, in the method herein the friction grip between tool and skin during any one stroking movement will depend upon: 1) The initial static coefficient of friction; 2) the subsequent kinetic or dynamic coefficient of friction, which is lower than the static value; 3) and the vector forces applied to the tool.

Surprisingly friction, by which is meant the resistance to sliding and therefore grip is theoretically independent of the area of contact. In the method, a tool is employed with a resiliently deformable face that when subjected to an externally applied vector force applies an even pressure over a relatively large area of skin thereby ensuring pressure is maintained uniformly at safe and comfortable levels and grip also is distributed evenly, avoiding differential slippage within the contact area during sliding, which causes localised uneven stretching that distorts the outer layer of the skin, which is common in hand applied cosmetic and deep massaging processes.

Therefore a beneficial ‘grip and slide’ movement during stroking is defined by the application of uniform contact forces applied over a defined relatively large area, the area suitably being relative to four bunched fingers on a typical small female hand and is estimated to be greater than 450 mm² and preferably greater than 1000 mm², and still more preferably greater than 2000 mm² thereby enabling large areas of skin to be treated more rapidly.

The direction of sliding being preferably along the longest axis of the friction face of the tool and the distance of sliding is preferably limited to 50% of the tool's longest axis, especially when treating the face to minimise potentially distorting shear stress transitions within the skin at the sliding tool edge.

The cosmetic method herein may include the additional step of applying a cosmetic (e.g. topical) formulation to the outer skin surface. The cosmetic formulation may be in fluid (e.g. liquid, foam, powder or paste) or solid form. In aspects, such application of cosmetic formulation may be performed either prior to, at the same time as or subsequent to the step of applying a vector force to the tool.

The exact nature of the cosmetic formulation will depend on the particular cosmetic effect to be enhanced and in aspects, may be selected from skin care such as depilatory, cleansing, moisturising, colouring, anti-ageing or shaving formulations.

In aspects, the cosmetic formulations are applied while simultaneously removing excess adipose (fatty) deposits from under the skin, and improving elasticity by training fibrous cutaneous tissues, firming muscles and improving vascular and lymphatic functions, thereby further improving bodily shape and appearance.

In aspects, the direction of the vector force alternates: in a first half cycle the second vector component acts in a first direction parallel to the outer skin surface such as to apply a first lateral stress component to said one or more subcutaneous layers, and in a second half cycle the second vector component acts in a second (i.e. opposite to the first) direction parallel to the outer skin surface such as to apply a second lateral stress component to said one or more subcutaneous layers. In aspects, the rates and magnitude of the second vector component in the first and second (i.e. opposing) directions are approximately equal.

To more fully exercise the one or more subcutaneous layers during each half cycle, the elastic limit of some subcutaneous tissue, which is visco-elastic, is exceeded and is distorted, the distortion being reversed during the next half cycle. By repetitively exercising the one or more subcutaneous layers with said alternating vector forces at regular intervals the bodily appearance is improved.

In embodiments, the vector force is applied in the approximate direction of the axis of contraction of nearby muscles and induces hypertrophy therein.

In embodiments, during each cycle the friction face that is in contact with the skin accelerates in a first direction and deforms the skin before and during sliding, then the friction face decelerates and stops, the friction face then accelerates in the second opposite direction and deforms the skin before and during sliding, then the friction face decelerates and stops.

In embodiments, the direction of sliding in the first direction is opposite the direction of sliding in the second direction save for any small displacements that translocate the tool across an area of skin.

In embodiments, the velocity of deformation is the same in the first and second half cycles.

In embodiments, the distance traveled by the friction face in either direction varies between 0.5 to 500 mm

In embodiments, the coefficient of friction between the skin and the friction face rises above 0.5 at some point during each cycle.

In embodiments, a fluid film is placed between the friction face and the mammalian skin.

In embodiments, the fluid film includes a topically applied formulation that interacts with cutaneous tissue.

In embodiments, the topically applied formulation assists with cleaning, exfoliating, a depilatory process, a skin conditioning process, an anti-ageing process, a shaving process, or an antiseptic process.

In embodiments, the cosmetic method improves vascular and lymphatic functions, and reduces adipose deposits in subcutaneous tissues.

In embodiments, the cosmetic method is for treating human lips in which the average contact pressure ranges between 3.3×10⁻⁵ and 4×10⁴ N/mm² over an area greater than 100 mm².

In embodiments, the cosmetic method is for treating parts of the human face in which average contact pressure ranges between 3.3×1⁻⁵ and 1×10⁻² N/mm² applied over an area greater than 450 mm².

### Frictional Tool

There is also provided a friction tool for use in a cosmetic method for the treatment of mammalian skin.

The friction tool comprises a body, which body defines a support having a planar support face. Planar is used herein to describe a predominant association with a particular plane, which means the support face may be substantially flat although not perfectly flat, thus the surface may also be slightly curved in one or more planes. A resiliently deformable friction pad is provided to the support face. The friction pad is suitably resiliently deformable along at least one axis. The friction pad defines a friction face.

In one aspect, particularly suitable for use in shaving methods the friction pad comprises a lofty non-woven fibre material. The lofty spaced apart nature of the fibre mechanically engages with the hairs of an adult male face, thereby producing significant friction between those hairs on the surface of the adult male face and the frictional face of the pad.

In another aspect, the friction pad comprises both a compressible foam layer and a layer of friction-enhancing material defining said friction face. It will be appreciated that the compressible foam layer rests adjacent to the planar support face and that the layer of friction-enhancing material rests outermost to provide the friction face.

Suitable friction-enhancing materials include rubbery, friction-enhancing materials. Thermo plastic urethane (TPU) and thermoplastic elastomers (TPE) are suitable friction-enhancing materials. In embodiments, the friction face has a coefficient of friction when sliding against dry mammalian skin of greater than 0.5.

Applicant has also found that it is desirable in use of the tool herein to avoid high stress transitions at the sliding interface with the skin as an edge of the frictional face of the friction pad slidingly engages an outer (cutaneous) layer of the skin.

In a first improvement herein, such high stress edge transitions are essentially avoided by providing ‘soft’ edges to the frictional tool. Thus, one or more edges of the friction face of the friction pad project beyond the planar support face to provide less support and soft edges.

In a second improvement herein, such high stress edge transitions are reduced by maximising the area of frictional contact thereby minimising the edge transitions experienced at a point on an outer skin surface as it is treated.

In embodiments, the body includes a handle for manual holding thereof. In embodiments, the handle is provided to one end of a shaft from which extends the support.

In embodiments, the friction pad comprises a flexible resilient material and the body comprises a stiffer material.

In embodiments, the friction face is rough, comprising many irregularly shaped, flexibly interconnected friction elements that interlock with the skin roughness to provide high levels of non-aggressive lateral static and dynamic frictional coupling when pressed against mammalian skin.

In embodiments, an edge on the friction face is less stiff than its central area.

In embodiments, the friction pad comprises polymer fibres that are mainly oriented in the x and y planes.

In embodiments, the support is coupled by members to a holdable area distant from the friction pad.

In embodiments, the support face and friction face are shaped either as a rectangle, a triangle, a circle or an oval or a combination thereof.

In embodiments, the support face has a flat area defined by dimensions in the x and y plane and has formed features in the z plane such as a radius or chamfer around the edges.

In embodiments, the friction tool additionally comprises a hand holdable hollow object with fillable space therein and with means of dispensing stuff therefrom, wherein the friction face attaches to the hollow object.

In embodiments, the friction tool additionally comprises a hand holdable hollow object with a multiplicity of friction pads stacked therein each with a friction face thereon, the tool with means of releasing friction bodies one at a time via an orifice. In embodiments, the stacked friction pads are impregnated with a chemical formulation.

In embodiments, the support face used to support the friction pad is a face on a fillable container or the end cap of a container.

In embodiments, the friction face mounts on the exterior of the body and with fluid stored within the body for dispensing therefrom.

In embodiments, the body comprises a hand holdable planar trowel like form with the support attaching thereto.

In embodiments, the friction tool additionally comprises a second face for rubbing located on a second face on the tool.

In embodiments, the friction pad is detachably attached to the body.

In embodiments, static friction pads are positioned either side of an alternating pad.

In embodiments, a lateral force applied to alternate a pad carrying a friction face is provided by a powered device.

### Additional Description of Friction Tool

The friction tool herein is suitably a chemical-mechanical tool employing a relatively large area high friction face that is pressed against the skin with a relatively moderate force to provide uniform frictional engagement with the skin over a relatively large area and moving said frictionally engaged area systematically over the skin by sliding backwards and forwards to exercise the tissues under and around the area of frictional engagement.

The friction face is suitably conformable, which means it is flexibly deformable because it is resiliently compressible, when pressed against a body takes the shape of the body and forms a relatively large uniform area of frictional engagement therewith. Upon applying a vector force to slide the tool it stresses and strains cutaneous tissue around the frictionally engaged area and subcutaneous tissue under the frictionally engaged area, the tool face is designed to grip and support the skin laterally.

Unlike the background art, means are provided herein for tissue to be deliberately strained laterally beyond its elastic limit, first stretched then compressed to restore it to its original shape by alternating the direction of the applied stress. This is not done in the background art because it was said to be detrimental to apply stress levels that strain the skin because of the risk of permanently enlarging the skin. The method and tools herein therefore provide means of repeatedly reversing the direction of deformation, whereas in the background art rotary motions in the same directions are mostly favoured. The background art does not anticipate or disclose a tool for applying rapid massage, applied with a large single sided high friction tool designed to strain subcutaneous tissue while only stressing associated cutaneous tissues as it simultaneously applies and spreads and rubs in cosmetic substances to the skin.

The tool is sized so that a typical treatment lasts only a few minutes, typically less than 5 minutes, most commonly between 2 and 4 minutes, whereas treatments in the background art lasts typically 20 minutes or more.

The friction pad is made with resiliently deformable material and the body is therefore resiliently deformable, which deformation is conveniently specified in terms of compressibility, upon which compressible body is carried a frictional rubbing face hereinafter referred to as the friction face, which friction face is also resiliently deformable and its frictional behaviour is specified in terms of its coefficient of friction, which is described further herein later.

The resiliently compressible friction face when pressed against an irregular shaped surface (such as, for example, part of a human face) will adjust its shape to fit the face. Then upon sliding, it further adjusts and follows the changing shape as it slides over an irregularly shaped surface and thereby maintains close frictional engagement (contact) therewith during sliding.

The friction pad is mounted on a support, which supports the friction pad. The support may vary in construction from the one extreme where it is ridged to the other extreme of being highly flexible, but at all times the support is stiffer than the friction paid and the actual combined stiffness (stiffness meaning resistance to deformation), is chosen to meet the requirements of the tool function.

For example, a preferred use for the tool is massaging while applying shaving lubricants, for which the tool is only required to operate over the lower face and neck. It was found that the optimum size and shape roughly resembles a traditional shaving brush, with a soft (soft meaning easily deformable) resilient friction pad mounted on the end of a stiff (barely deformable) support that also acts as a container and/or dispenser. The friction pad and friction face located at one end or on a side towards an end or some similar combination as illustrated later by way of example later herein, Thus a fluid dispenser can be attached onto or incorporated into the tool.

On the other hand a tool for applying moisturiser can have a resilient friction pad of soft fibre or foam supported by a support that is little more than a relatively flimsy folded card, the card itself is also resiliently deformable, as illustrated later herein by way of an example.

In all cases the friction pad is made with less dense material than the support, the density of the material of the friction pad being in the range 10 to 120 kg·m³. The shape, thickness and actual materials are described in more detail later herein.

A region on the support provides means of holding the tool. This region is an area for gripping either by human hand or by other means such as a mechanical device like a robot that simulates some or all of the motions that are provided by a human hand when using the tool. The actual operation of the tool when hand held is most commonly hand powered but may be power assisted by the addition of a vibrator device for added convenience.

For manual operation the support is shaped to be gripped between thumb and fingers or wedged between first and second finger; a further area is provided for applying additional pressure on the support, the further area pressed with fingers or the palm of the hand as illustrated by way of example later herein.

The support having a first region coupled to a second region, the second region being distant from the first region by an amount sufficient to keep the gripping or pressing fingers and hand away from the rubbed skin.

The support of the tool is shaped to accommodate within it, or have coupled to it, a reservoir for storing and dispensing a fluid during rubbing, the fluid in the form of a chemical formulation that provides a beneficial cosmetic function when rubbed onto the skin. The tribological properties of the applied compound and the amount applied are selected to provide friction levels compatible with those required to exercise the skin.

Now referring to the friction pad, the resiliently compressible material of the friction pad and the friction face thereon is selected to be approximately similar or slightly stiffer (less deformable during compression) than the skin covering soft tissues on the lower human female face and less stiff than the skin covering skeletal bones about the chin and upper cheeks. Overall the tool, that is the combined first and second bodies, being sufficiently compliant (resiliently compressible) so that when pressed against an uneven surface such as said lower facial tissues it forms a frictionally engaged area with a substantially uniform contact pressure, which area is relatively large. Relatively large means an area that is greater than the average combined contact area of four (4) small adult female bunched fingers tips, which are the most commonly used rubbing means for applying and rubbing cosmetic lotions onto the face, the typical frictional contact area of said fingers is estimated to be above 400 mm², thus the frictionally engaged area of the friction face of a tool for treating the face (except the lips) is larger than 450 mm² but significantly the contact pressure due to the fingers is highly irregular because the fingers are not flat.

Some measurable physical attributes of suitably resilient compressible first bodies were determined experimentally by testing a variety of different tool constructions, and are summarised as:
a friction pad that is compressible within a range 1 to 90% (thickness reduction) over more than 50% of the area of the rubbing face thereon when subjected to a compressive force of 5 kPa (kg/m²) for less than 0.5 seconds and upon fully unloading the compressive force the body recovers in less than 0.5 sec to a compression set of less than 50%.

The term ‘compression set’ means the difference between the original or pre-compression thickness of the friction pad and its thickness after a specified period of recovery after fully removing the compression force.

Reference to skin stiffness herein means the resistance cutaneous and subcutaneous tissues collectively present when subjected to deformation, either in compression, tension or shear, this is influenced by the amount of soft tissue underlying the skin, which varies hugely over the human face. On the lower face cheeks there is deep soft tissue, perhaps 10 mm or more but on the forehead there is little soft tissue, perhaps less than 2 mm, therefore there is very little subcutaneous matter to deform. To treat bony areas, resilient first bodies are preferred that are compliant so they are able to adopt the shape of the bony area and prevent the contact pressures and shear stresses rising to levels where skin might be damaged.

To provide the desired sliding friction characteristics, the friction face is made slightly rough, by which is meant it is at least slightly rougher than an average 30 year old female facial skin. The friction face roughness comprising many small irregularly shaped, resiliently deformable and flexibly interconnected friction elements (contacts) that interlock with the skin roughness during frictional engagement to provide high levels of non-aggressive lateral static and dynamic frictional coupling when pressed and slid against skin. The materials of the friction face may be either a foam with either open or closed cells, natural or man-made fibres in a woven sheet or a non-woven web, or a flat sheet like paper or card or polymeric film. The polymeric film may be thermoformed and carry protrusions, which protrusions have cavities therein that are also used for storing and dispensing materials

The friction face may be porous because it is on a porous or absorbent friction pad such as an open cell foam or a fibre web. The friction face may also be porous because it is made with a perforated high friction film covering an absorbent body. The absorbent body may absorb and store matter and release the stored matter during sliding (rubbing) and thereby transfer it onto the skin, the transferred materials including liquids, slurries or dry particulate matter. Equally, material may transfer from the skin into the porous friction face during sliding; and there may be circumstances where material is first—transferred out from the friction face onto the skin during sliding (rubbing) and after mixing with dirt or particulate on the skin, the thickened residues are then second—transfer back through the friction face into the absorbent friction pad as sliding continues.

If the friction pad carrying the friction surface is made with fibres it may be in the form of a woven, a knit or a non-woven web, either a thin hydro-entangled, spun-bond or melt-blown into thin wipe like material, or a thicker needle punched felt like web or a lofty resin bonded open structure, perhaps bonded with an acrylic binder typical of scouring pads or some combination formed with layers of these. The layers may also include natural fibres such as cotton. The preferred materials are fibres, either staple or continuous, formed with polymers selected from the group consisting of polyolefin's, polyamides, polyesters, polycarbonates, polypropylenes, polystyrenes, thermoplastic elastomers, fluoro-polymers, vinyl polymers, viscose polymers, acrylic polymers and blends and cross-linked copolymers thereof.

A typically lofty low density non-woven web suitable for use as a friction pad is made with crinkled staple fibres of lengths of between 0.2 cm to 7 cm or with longer (virtually continuous) straight fibres, the fibres coupled by needle punch entanglement, adhesive or resin bonded, or thermal bonding by blending in lower melting point fibres then heating to selectively melt these lower melt fibres—these webs being typical of those used for skin contact use such as make-up removal. They may take the form of a single or multilayered stack, creped or pleated shaped to suit the purpose.

The physical characteristics of the friction pad and friction face can vary widely between applications. It is difficult to provide precise guidance on the most suitable density and stiffness of the friction pad material. As a guide for use on a male face, for applying shaving lubricant, a lofty non-woven web of resin bonded non-woven nylon or polypropylene with a density of 50 kg/m³ and web thickness of 5 mm made with a fibre of 10 micron diameter fibre was satisfactory. The web had a natural roughness of about 0.75 mm Ra. The web should have resilience so that it can engage with the facial stubble (hairs) and spring into and out of detents in skin roughness. A similar friction face for exfoliating and applying moisturiser or skin colouring dye to a female face or legs used 65 kg/m³ web, the web thickness being 2 mm and the fibre thickness was 7 micron. The web had a natural roughness of about 0.5 mm Ra. These webs often have one side more dense than the other, or they may have more bonding one side thus they may be stiffer on one side. Care is needed to specify which side is to be used as the friction face.

The friction pad and friction face thereon can be formed with micro-fibre materials, that means materials made with fibres less than one denier that means they typically use fibre diameters of less than 10 microns that are formed into woven cloths with many fibre ends that are split or otherwise treated to form hooks that catch dust and particulates and slice up grease deposits, they are therefore useful for cleaning skin. Because they entrap particulates they suffer from the risk of spreading infection, therefore if used as a friction face they should be used only once and then washed clean or discarded.

Non-woven paper wipes, or polymer reinforced natural fibre wipes, or absorbent wipes made with materials such as viscose/polyester combinations may all be used as low cost friction face materials. They may form a single use device or be removeably attached to a support. Wipes offer many possibilities for use as pre-wetted dispensing mediums for applying cosmetic and skin care treatments. These relatively thin wipes may actually constitute the entire friction pad of the tool with the friction face thereon and may conveniently be removeably attached directly onto the support.

The strength of wetted paper wipes proved to be a limiting factor during frictional rubbing; therefore paper wipes are suited only to applying wet cosmetic treatments where the massaging requirements are minimal. If the paper can be used dry or is impregnated with a dry medium or is suitably rough or porous for dispensing dry powder, or perhaps less rough and using a powder substance as a dry lubricant, then they may also be suitable for frictional engagement and rubbing against skin to massage.

High friction films for rubbing against skin are preferred for many uses such as applying skin-care formulations and may beneficially use thermo plastic elastomers (TPE). These are blends of plastics (usually olefins) and synthetic rubbers (often urethanes) and in particular, these are known as thermo plastic urethane (TPU). Among their attractive features are a warm high grip feel on skin, they have a high natural coefficient of friction on skin which can be raised further with the introduction of clean (soap free) water. This material with a specific gravity of 1.2 does not float but is attractive for its dielectric heating properties that are helpful during thermoforming. It is available with a useful hardness (stiffness) range quoted as typically 80 to 85 on the shore A scale. Formed sheet made with TPU in thickness ranging from 25 micron to 400 micron proved very durable and soft to touch with significant elasticity. They always recovered their original form after severe crumpling during use and are preferred for applications where scraping with hard materials like abrasive is unacceptable. Suitable materials are available from Epurex Films Gmbh, a Bayer Company sold under their registered brand name ‘Walopur’ and marked 4201 AU or U073.

Poly [styrene-(block)-ethane-co-butane-(block)-styrene] (SEBS) materials are amenable to formulation manipulations that provide a wide range of Shore hardness from 30 A to 90 A. These materials also have soft high grip feel and with hardness in the range 50 A to 70 A they are of practical use for friction faces.

Improved chemical compatibility is available with thermoplastic vulcanised materials (TPV) or thermoplastic natural rubber (TPNR) which is produced by blending natural rubber with PP and the material is thermoformed at temperatures similar to PP. TPV is partially vulcanised dynamically during blending whilst TPNR is said to have no cross-linking of the rubber. The TPNR with higher natural rubber content is the softer product. Both have the processing characteristics of a thermoplastic material and functional properties of a vulcanised rubber. Hence both materials are thermoformed on the same tooling as used for PP and PE, but the formed sheet product behaves like vulcanised rubber. TPV and TPNR materials are preferred for use on skins vulnerable to infection. An example of these are the 8000 series Santoprene (registered trade mark) thermoplastic rubbers supplied by Advanced Elastomer Systems, an Affiliate of ExxonMobile Chemicals, 388 S. Main Street, Akron, OH 44311 USA, which materials are said to be USB class 6 compliant and this means they are approved for use with exposed traumatised bodily tissue and fluids in the USA. The same company supplies a product with superior low gas permeability called Trefsin (registered trade mark), which has lower permeability and therefore is superior for long term shelf storage when storing fluids within the cavities of the formed sheet. Generally materials with Shore hardness in the range 50 A to 60 A are preferred for treating sensitive skin.

The method has benefits for applying acne treatments where it provides useful mechanically enhanced skin cleaning as it topically applies antiseptic lotions. By using a series of preloaded first bodies in the form of removeably attached pads or wipes, a prescribed course of treatment can be packed in a single package. It is already known that non-woven materials in the form of pre-wetted wipes such as the “Stridex” (registered trade mark of Bayer Corp., Consumer Care Division, Myerstown, Pa. USA) or the teachings of U.S. Pat. No. 5,879,693 in which the acne pad itself is described as 75 gram 149-189 tight waffle Novonnette material, in which each pad is impregnated with 1.56 gram of the treatment material. Acne is a generic term for a number of cosmetic skin disorders associated with hair follicles treated by topical formulations, which in essence are antiseptic cleaning compounds. It is important that the treatment is applied in a consistent disciplined way and once applied that the potentially contaminated treatment material is carefully disposed of.

Both the first and second bodies can be made with foam materials. Suitable materials include, but not limited to cross-copolymers, or polyolefin's and including polyurethane's, polyvinylchloride's, polyethylene's and polypropylene's. They may have open or closed cell structures. The open cell structures being absorbent are useful when the friction pad needs to be made absorbent and they are highly deformable and therefore soft. The closed cell structures are available in stiffer sheets (less compressible and more resilient (springy) and can be selected from a wide range of commercially available sources with densities ranging from 15 kg/m³, up to 120 kg/m³. Typically they are available from, for example Zottefoams plc of 675 Mitcham Road, Croydon, Surrey, CR9 3AL UK. And these are very light weight while being highly resilient and are highly suitable for use in making the second bodies.

As a guide a low cost reusable tool for applying skin care lotions can be constructed with a friction pad made with 1.9 mm thick foam, (similar to the low cost materials used for laminated flooring underlay) such as polyvinylchloride (pvc) foam sheet with a density of typically 30 kg m³ that is covered with an impervious 50 micron thick polymeric membrane of TPU bonded thereto to form the friction face. The foam has a natural roughness that is similar to skin and the film when bonded to the foam it assumes a skin like roughness. The support is formed to a suitable shape by folding sealed by laminated card. Such tools have provided working lives in excess of 50 applications of intensive 2 minutes application of moisturiser on a male face after shaving.

The friction face on the friction pad can be removable either by replacing the entire friction pad or replacing the friction face sheet covering a face on the friction pad. Such a sheet may for example (s discussed earlier herein) be a wipe made with non-woven paper or cloth, a woven cloth, a foam, or polymeric film, the wipe being removeably attached to the friction pad. The wipe may be impregnated with a treatment substance, either wet or dry, for application to the skin by rubbing. Low cost paper wipes provide low cost single treatment means, used with a washable long life first bodies made for example with folded laminated card covered with impervious film, or polymeric moulded cases. Wipes are also useful for combining two substances at a point of delivery where a first substance is pre-applied to the skin—perhaps by finger or another applicator and a second (that is probably a chemically active substance), which is impregnated into the wipe and is then rubbed on. Used contaminated wipes must be removed and appropriately disposed of.

The coefficient of friction of the friction face is a design parameter of the tool and is directly influenced by the choice of materials used on the friction face, but its determination in relation to the use of this tool is experimental because it is affected also by the presence of friction modifying materials, such as powders or fluids. The classical approximation of the force of friction known as Coulomb friction is F=μR a mathematical relationship, where F is the friction force and R is the reaction force of the skin which is equal and opposite the applied normal force maintaining the sliding face in contact. μ is the coefficient of friction a constant for particular conditions, μ is a dimensionless quantity that is constant for a given set of conditions, and is determined by experiment. In mechanics, this figure matches theory to observed results and bears no relation to the actual causes of friction. It indicates the amount of friction that occurs between different combinations of sliding materials. Conventionally there are two values for p, one for overcoming the static resistances and dynamic (otherwise referred to as the kinetic), which is usually a lower figure and is that required to maintain sliding. The symbols for these are μₛ for static values and μₖ for kinetic respectively.

The method determining the coefficient for the friction face involves the steps of first pressing the friction face against the skin (first force) to induce reaction force R and then applying a lateral force (second force) F to slide the face against skin.

In vivo frictional properties of human skin have been measured in studies of prosthetic attachments and hand grip and the following figures are quoted by way of a guide, although they do not specifically refer to the same conditions pertaining in the method, they provide a useful reference. Typical average figures are quoted by Zhang M and Mak AF of The Rehabilitation Engineering Centre, The Hong Kong Polytechnic University, Kowloon published in Prosthet Orthot Int 1999 August 23 (32) pages 135-41 as follows: “In vivo frictional properties of human skin and five materials, namely aluminium, nylon, silicone, cotton sock, Perlite, were investigated. Normal and untreated skin over six anatomic regions of ten normal subjects were measured under a controlled environment. The average coefficient of friction for all measurements is 0.46+/−0.15 (p<0.05). Among all measured sites, the palm of the hand has the highest coefficient of friction (0.62+/−0.22). For all the materials tested, silicone has the highest coefficient of friction (0.61+/−0.21), while nylon has the lowest friction (0.37+/−0.09)”.

Another source Buchholz B, Frederick LJ/. An investigation of human palmar skin friction and the effects of materials, pinch force and moisture. Ergonomics 1988; 31(3):317-325 quote similar Coefficient of Friction for skin that broadly agree with the above as follows:

Coefficients of friction for skin sliding against various materials:

| Material | Dry | Moist | Combined |
|---|---|---|---|
| Sand Paper (#320) | — | — | 0.61 + 0.10 |
| Smooth Vinyl | — | — | 0.53 + 0.18 |
| Textured Vinyl | — | — | 0.50 + 0.11 |
| Adhesive Tape | 0.41 + 0.10 | 0.66 + 0.14 | — |
| Suede | 0.39 + 0.06 | 0.66 + 0.11 | — |
| Aluminium | — | — | 0.38 + 0.13 |
| Paper | 0.27 + 0.09 | 0.42 + 0.07 | — |

The above test results were obtained by standard mechanical methods under controlled clinical conditions and are provided herein as a guide for μₖThe data was not obtained from the human face and neck, the area of most interest herein, but were obtained from tests on the hands and inside of forearms and neither was the friction similar to that used in the method.

Our tests showed a wide range of variation of μₖ, due firstly to variations of the skin itself and secondly to the environmental conditions pertaining during the tests. For example, friction tests on the male human face showed a huge spread ranging from 0.7 to 1.8 for μₖ. due to beard stubble that mechanically engaged (interlocked) with the friction face. Thus friction was anisotropic because the beard grows downwards, thus friction was greater on the up stroke. These figures referrer to a water wetted beard because it was found to be impractical to slide the tool dry due to high friction.

It is difficult to precisely define the skin condition as either dry or moist, and this influences μₖ. In practice, the skin conditions are likely to vary over an area being treated with the tool; therefore, the figures quoted are a guide for μₖ based on the assumption that average skin conditions will have some slight amount of moisture present but the skin feels dry to the touch.

From our test the average figure for μₖ for a dry friction face of non-woven fibre in sliding contact with dry female skin appears to be about 0.5. Tests with a range of friction face materials indicate a figure averaging above this is desirable for the tool. Consistent measurements of μₖ>0.5 were obtained between a tool with a friction face of TPU over pvc foam friction pad sliding against freshly washed female facial skin that was rinsed and dried with a towel, the humidity being typical of a washroom of about 80% at 20° C. There was no evidence of anisotropic behaviour. Therefore a figure of μₖ>0.5 is a preferred value for the friction face on the tool when sliding against dry human skin without hair.

If the reaction force R spreads over too large an area frictional engagement becomes less uniform and the tool becomes less effective. Thus, the area of frictional engagement must be sized to uniformly exercise a usefully large area, but not so large that insufficient or inconsistent frictional engagement occurs.

The interaction between the first and second bodies and their combined stiffness (resistance to deformation) has a large influence on the effectiveness of the tool. By making the friction face compliant (this means able to follow a complex three dimensional shape) yet stiffer in one plane, makes it is easier to control the tool as it traverses a complex shape such as a human leg and maintain reasonably uniform contact pressure therewith. Therefore since the friction face is deformable it is initially made substantially flat and it deforms in use to match a three-dimensional shape. The outline shape of the friction face being either: an ellipse, a rectangle, a triangle, a circle or some combination thereof, such as a heart shape, the outline shape with one or more rounded features. The flat face may have an aspect ratio of length to breadth about a centreline in the range 1:10 to 10:1 and are generally uniform about the centreline.

The outline shape of the friction face on the friction pad is bounded by dimensions in the x and y planes and the friction pad has thickness in the z plane. Typically the thickness of the friction pad in the z plane ranges from 25 microns to 25 mm. If the support is flexible it is usually made slightly smaller than the friction pad, so that it provides slightly less support towards the edge of the rubbing face, which makes the rubbing face softer at its edge because it is more deformable (compressible). If the support is stiff like a container, for example a moulded plastic container, the support face shaped in the third dimension—the z plane with a radius or chamfer around the edges of a flat or slightly domed face. The chamfered edge provides less support for the friction face at its edge making the edge more deformable (less stiff).

The shape of the support body and the support provided may be equally stiff in both x and y planes, or, the support may provide more support in a first plane and less in a second plane, the arrangement adopted depends on the application. For use on large limbs, a blade like tool is preferred because it is larger, allowing longer sweeping/sliding action somewhat similar to the action used in plastering a wall or ceiling, this blade like tool having a friction face that is stiffer along its longest axis to improve control, the support conveniently with folded card.

The tool's friction face is sized to apply effective massage within the time it takes to apply and work in a typical shaving lubricant, which was on average measured at about 1 minute to apply and work in. By iteration it was found that to ensure the area can be covered and massaged adequately during shaving the area of frictional engagement between friction face and the stubble on the face needs to be at least 2% and preferably 3% or more of the superficial area to be treated. Here the word superficial means a two dimensional estimate of an area on a complex three dimensional shape like a human face. Typically the superficial area of the bearded part of the face when shaving is about 425 cm² thus using the 2 to 3% rule an average area of frictional engagement required for high rate massage ranges between 8.5 cm² up to 12.75 cm² provided with a friction face on a tool with an area of about 14 cm² and shaped as a flat regular ellipse with soft edges. Circular tools were also tested but they were found to have less good access around the nose and ears.

In the case of applying a moisturiser, for example after shaving, when a different larger tool is used because the area to be treated is larger. In such an application it is estimated that the superficial area treated is 65% more than for shaving which approximates to 750 cm², and applying the 2 to 3% rule gives the average area of frictional engagement between 15 and 21 cm². A convenient sized tool was found by experiment to have a friction area of about 45 cm². The optimum friction face shape was found to approximate to a heart shape (as appears on playing cards), with a narrowed end with rounded point for accessing the skin around the eyes and the nose and a broad beam for treating the large areas of the face and neck, and with a soft edge.

Experience showed when massaging the human face, an average numerical ratio between the area of uniform frictional engagement in mm² divided by the contact circumference in mm should be preferably greater than 5:1 and most preferably greater than 10:1 to minimise the edge contact transitions when the treatment is applied rapidly (and vigorously) within a period of the order of 2 minutes. These ratios are averages, the actual ratio can vary beyond these limits when rubbing around the eyes for example. The ratio also varies with the depth of the subcutaneous soft tissue across the face, deep soft tissue requires a larger area of frictional engagement to ensure the induced lateral stress fully exercises the deepest tissues.

### Additional Description of Cosmetic Method

A method is provided for using the tools as described herein before for applying to mammalian skin to exercise and condition the subcutaneous tissues and thereby improving bodily shape and appearance.

In aspects, in the method herein the friction face of the tool is placed against and frictionally engaged with skin, the skin with or without appended hair, and
I. a vector force is applied to the tool, the vector force having a first and a second component,
II. the first vector component acts normal to the friction and forces the tool against the skin causing it to assume and match the shape and fit snugly against at least part of the mammalian body to be treated and thereby forming a frictional engagement over an area with uniformly distributed friction over this area, which resists sliding,
III. the second vector component acts parallel to the friction area and overcomes the said frictional resistance and causes sliding,
IV. upon sliding, compressive and shear stresses are applied to the skin and the hair mechanically engages with the spaced apart fibres in the friction face to exercise and lift the hairs preparatory for shaving.

Skin exhibits visco-elastic properties, which behaviour is one in which hysteresis is seen in the stress-strain curve as stress relaxation occurs. Practically, this means that upon moderate stretching (stressing) skin initially expands elastically and if immediately relaxed returns to very close to its original shape/size, but the longer stress is maintained the less it springs back, hence it becomes permanently extended and is said to be ‘strained’. Therefore to avoid distorting the skin it is important that no area on the treated skin be subjected to uniaxial stress alone, either steady or varying otherwise permanent distortion occurs. If the direction of the second component of the vector force is made to alternate it reverses the direction of sliding and applied lateral stress, and if the resultant distances traveled in each direction are made equal, successive equal and opposite strained deformations cancel.

For small deformations such as those produced with the tool described hereinbefore, mammalian skin displays near linear visco-elasticity. These deformations can be visualised with the help of a mechanical model proposed by James Clerk Maxwell of a spring in series with a damped dash pot and is therefore described as a Maxwell material. Any small extension in a Maxwell material is reversible over a short time, hence by alternately stretching and compressing the tissues at the same rates in opposite directions the effects substantially cancel and there is minimal net change in shape, providing the deformations are made one immediately followed by the other. Beneficial adaptive changes are induced by subjecting the skin to low to moderate cyclical alternating strain, because the repeated exercising helps train the load carrying fibres in both the cutaneous and subcutaneous tissues layers to better respond to internal muscular applied deformations. This improves the appearance, elasticity of the tissues and their dynamic response in the direction of the applied stress as well as biological functions such as vascular function and lymphatic drainage.

Frictional engagement between the friction face and the skin is determined by one or more of the group comprising:
I. Intermolecular forces acting between friction face and skin
II. Mechanical interlocking due to deformations of skin and friction face,
III. Mechanical interlocking of appended hair with the friction face,
IV. Viscous shear within materials placed between the friction face and the skin.

Upon application of the vector force, first vector component causes static frictional engagement then upon application of the second vector component sliding occurs which is described as kinetic or dynamic friction. All the above listed factors influence both static and dynamic friction.

The intermolecular forces provide grip which is greatest with materials such as rubbers and in particular thermoplastic urethanes and similar materials as described herein before. Mechanical interlocking occurs as resilient slightly softer skin is forced into the roughness of a stiffer friction face. If hair is present on the skin and the friction face is fibrous then the hairs engage with the fibres to cause frictional resistance. Both the static and dynamic levels of friction are affected by the presence of a material at the sliding interface between the friction and the skin. The materials may be liquids or dry fine powders. If wet it may be due to natural excretions from the skin or to a topically applied compound, the compound as well as having tribological characteristics also having a functional cosmetic purpose and it is the benefits derived by combining the application of these functional cosmetic lotions with massage done in the time it takes to apply the cosmetic lotion that is a preferred feature of the method of this invention.

The topical application of fluid at the sliding interface may reduce friction if it acts as a lubricant; or it may raise friction in which case it acts as an anti-lubricant. The term topical describes a fluid introduced locally to the skin surface. The fluid may for example be a compound created for a personal care purpose such as cleaning or colouring (changing the colour) of the skin by simply rubbing the formulation onto the skin. However, its effectiveness is likely to be improved by the method described herein because the mechanical agitation provided by the sliding friction improves wetting and absorption and potentially will drive chemical and biological interactions.

The viscosity of the introduced fluid compound may vary from a thin free flowing liquid up to a thick gel or it may beneficially be thixotropic, which means it thins as it is deformed. The compound may also contain mild abrasive, providing the abrasives are fine and do not damage the skin during exercise. It is desirable at the microscopic level that a thin film of fluid, perhaps only a few molecules thick should always separate the friction face from the skin at the sliding interface to protect the skin.

The behaviour of thin films under the stress of sliding is described in Tribology (the science of lubrication) as elasto-hydrodynamic separation, it means that there remains a continuous film of material separating the friction elements on the friction and the skin during frictional sliding; therefore the skin is actually deformed through the separating film. This thin film provides sufficient shear coupling with the skin to remove dirt and dead skin platelets.

The pressure exerted on the film can become significant at sliding contacts and these high pressures are sufficient to drive fluid into and through microscopic damage sites in the stratum corneum from where low molecular weight elements more easily diffuse into the dermis. Also, the compound is forced down hair and sweat pores and penetrates the dermis. Thus during the method, the sliding improves topical wetting and adsorption on the microscopic scale. This improves chemical absorption into the dermis, which improves the function of chemical compounds formulated to chemically interact with cutaneous tissue and potentially subcutaneous tissue.

Thus the method may include the topical application of chemically active compounds whose functions are improved by the friction induced cutaneous and subcutaneous exercise.

Some examples of the function of the introduced fluid compounds are, cleaning compounds, exfoliating compounds, depilatory compounds and conditioning compounds such as moisturisers, anti-ageing compounds, shaving gels and soaps, and antiseptic cleaning compounds for the cosmetic treatment of skin disorders such as acne.

Compounds containing soaps or oils tend to reduce friction whereas water tends to raise friction, especially with rubbery frictions. Of particular interest are materials that change the frictional properties between the friction and skin during extended rubbing. For example many emulsions separate during rubbing and water evaporates causing the viscosity and viscous shear levels to rise, in some case making further sliding impractical.

Another example of this is applying a shaving lubricant in the form of a soap where the soap is applied to the friction face by impregnating it into the friction pad. The beard stubble engages with a fibre body and the friction is high, but soap has a low coefficient of friction and this immediately lowers the friction making sliding possible, then as the soap dissolves more friction elements are exposed and the friction rises influenced by the propensity of the unshaven stubble hair to interlock further with the rough friction on the friction face. It is as a result of hair interlocking that the facial tissues and especially muscles are very well exercised leading to an improvement in facial appearance due to hypertrophy after shaving. The high friction due to interlocking also has a beneficial effect on plucking out the ingrown ends. As sliding continues, the hairs become thoroughly worked and wetted and soften leading to a very satisfactory smooth shave. Shaving lubricants used with the friction pad may be either applied separately or through the porous friction face. The lubricants may be either lathering or non-lathering and preferably incorporate surfactants.

The thickness of the cutaneous layer on the human face is fairly constant at between 1 and 2 mm whereas the subcutaneous layer varies widely from less than 1 mm millimetre on the human forehead to more than 10 mm on the lower facial cheeks. Thus, when exercising the subcutaneous layer it is important that the gripped area of cutaneous tissue is large enough to fully stress the deepest soft subcutaneous material.

Upon applying the vector force and sliding, the skin under the tool is compressed and relatively lightly stressed laterally while the deeper tissues are strained laterally; and, concurrently the skin adjacent to the tool is strained laterally while its underlying tissues are mainly stressed.

This complex behaviour is unexpected and is governed by the size and in particular the uniform nature of the frictionally engaged area.

The area of frictional engagement must be large enough to effectively grip the cutaneous layer uniformly, which in turn stresses the subcutaneous tissues sufficiently to strain these either by stretching or compressing.

The minimum area of frictional engagement is determined by the depth of the soft tissue at any point being treated, but because of the variability of this depth it is difficult to reliably specify. Experience has shown that the ratio of contact area with the perimeter or circumference of the frictionally engaged area provides a useful guide to the effectiveness of the treatment applied to the subcutaneous soft tissues. The higher the ratio of the area divided by the circumference of the friction contact area the better the tool works and the figure should be greater than 5 and preferably about 10.

The frictional engagement between the friction face and skin needs to be substantially uniform so that upon application of the vector force the grip and coupling and resultant stress is uniformly applied over the contact area, despite any change in shape and size of the frictional engagement area during sliding. The frictional engagement laterally grips and holds the coupled cutaneous layer and moves it uniformly with the tool up to the point of slip and thereafter maintains a uniform sliding frictional coupling that provides a consistent shear stress across the stiffer cutaneous layer and into the adjacent softer subcutaneous layer. The alternating shear force exercises the soft subcutaneous layer under the area of frictional engagement via connective tissues, applying resistance exercise to the subcutaneous tissues as they are stressed against their skeletal anchorages; concurrently cutaneous (near surface) tissues adjacent the periphery of the sliding tool are either stretched or compressed during sliding and are resistance exercised against surrounding cutaneous tissue.

The term resistance exercise means stretching and compressing against a fixture as occurs when contracted muscles are repeatedly stretched under load to improve their efficiency as occurs in weight training.

By alternately straining the fibrous visco-elastic tissues of the skin as in resistance exercise, skin elasticity is improved by optimising load sharing between fibres therein, during which fibres tend to realign and unfavourabley oriented fibres that limit elasticity in a particular direction break. Thus by progressively stretching and compressing, the elastic range of the skin and its supporting tissues is raised in the direction of exercise, which is preferably in the direction of contraction of nearby muscles.

Experience has shown that quick effective massage of the face can be applied within the period it takes to apply a cosmetic lotion providing a large frictional contact area is employed, and this is impractical with any combination of human fingers alone (the most commonly used friction applicator tools). When using fingers the area and contact pressures is more variable than with a tool as described hereinbefore. It was observed that sometimes the palm of an open hand is also used to apply lotions over large bodily areas. The fingers and palm also result in less uniform coverage than with a tool. Hence the tool speeds up massage and provides a better result.

After a period of about 10 days of regular application of the method the skin was found to fit the skeletal frame of the face better improving face shape and with improved dynamic response, which means less slack and better response to jaw movement when speaking or smiling. Voids around the inside of the aural cavity (mouth) are reduced. The exercised muscles exhibit tightness, slackness of the jaw sockets is reduced noticeable when chewing. The exercise and training also improves the skins vascular functions and metabolism. Lymphatic drainage is improved; adipose fatty deposits in connective tissue are reduced. The reflectivity of the skin is improved by the tendency towards parallel alignment of the outer fibres of the dermis.

The condition of connective tissue is important because it supports the skin and anchors it to muscles or the skeletal frame and therefore contributes significantly to the smoothness and appearance of the skin. It also carries insulating fat that can become excessive if not regularly exercised. Relatively little was found in the literature concerning the biomechanical behaviour of connective tissue. Connective tissue are said to be composed of three classes of bio molecules, structural proteins (collagen and elastin), specialised proteins (fibrillin, fibronectin and laminin) and proteoglycans. The subcutaneous layer is said to comprise a loose matrix of fibres interspersed with significant fatty deposits. Mechanically, this appears to behave like a soft sponge that supports and can stretch with the skin. As this spongy matrix is exercised (stretched and compressed during the method), so it tends to exude excess fluids and/or fat from its structure.

Scar tissue can be an overgrowth of connective tissue and it was found that both scars and flat moles became less prominent after using the method.

While the common method is to use the tool with sliding strokes, the tool can be used for non-sliding deformation, for example when treating very thin skin. Non sliding strokes must be long enough for their deformation to reach into deeper subcutaneous and muscle tissues, thus their actual length will depend upon the depth of subcutaneous tissue at any point. Non sliding applications are useful around the eyes and lips where the skin is particularly thin and there is a risk of injury to the eye by inadvertent contact. Non-sliding massage with the frictional rubbing method described herein is conveniently done with small powered tools with side support pads, as illustrated by reference to diagrams later herein.

The minimum sliding stroke length depends upon the shape and size of the area to be treated and the depth of the soft tissue in any given location. For example on the legs sliding strokes can be 150 mm or more, done with long tools whereas on the face across the cheeks and up to the forehead they average 50 mm, around the mouth 20 mm and close to the eyes they may average as little as only 5 mm or less. Non sliding deformations range from 10 mm down to 1 or 2 mm, depending upon the depth of subcutaneous soft tissue. When treating the face it is important to minimise stress inducing edge transitions, an edge transition being an edge on the tool passing over a given point, therefore it is preferable to maximise the length of the rubbing face so the average length of the strokes are less than 50% of the length of the tool. This rule does not apply to non-facial areas.

The velocity of sliding and the resultant rate of deformation of the skin is also important. As noted earlier skin is visco-elastic and when subjected to a sudden impact or extension it may not have time to stretch elastically and instead shears or tears, thus the rate of change of the applied stress must be such that the skin can elastically respond to it and tolerate it without trauma. Similarly, the tool must decelerate without causing trauma or physical damage.

Providing the tool velocity changes at a rate that is within the elastic response time of skin, the tool being in frictional engagement actually supports the skin in direct contact with the tool during lateral acceleration and deceleration, in both static (non-sliding deformation) and dynamic (sliding deformation).

The skin around the edge of the static or sliding tool may experience high shear forces during acceleration and declaration. The tools are designed to have progressively less frictional contact towards their edge by making them softer or more deformable at their edge to reduce the risk of shear.

The invention therefore provides a cosmetic method for improving bodily shape and appearance of well-being. The term ‘Bodily shape’ means the shape of some parts of a mammalian body, especially in relation to the human face; whereas the term ‘well-being’ means a general healthy appearance, which includes surface smoothness, texture, colour and reflectivity of the skin. It also includes the lack of spots, rashes and other features that are detrimental to healthy appearance. For the purpose of this specification the term acne is used to describe a series of cosmetic blemishes on the skin.

The method provides means of frictionally inducing stress and strain in mammalian tissue to exercise parts of its constituent tissues. Mammalian means part of a mammal, either human or animal. Tissue means an aggregation of morphologically similar cells and associated intercellular matter acting together to perform one or more specific functions in the body. There are four basic types of tissue: muscle, nerve, epidermal, and connective. The epidermal tissue being skin with or without hair appended. The skin (the cutaneous layer) also having internal appendages, principally connective tissues that join the skin to the body.

While the tool and method is potentially useful for treating most areas of a mammalian body, it appears to be particularly beneficially when used around the human face and neck. On the face there are many muscles that are coupled to and are visible through the skin and these control the facial expressive reactions, such as smiling or frowning and the tool and method has been shown to be highly beneficial in improving these features.

The size and condition of the facial and neck muscles declines with age and cause cosmetic problems due to slack wrinkled skin especially around the lower face and neck and the tool and method has been shown to reduce these problems.

For areas such as the chest, back and limbs like arms, hands and feet there is less muscle attached to skin, therefore the benefits of friction-induced subcutaneous exercise are less evident.

The tool and method is useful for exercising irregular shaped deposits of adipose fatty tissue attached to the hypodermis, (the subcutaneous tissue immediately below the skin), which occurs in excess for example at the back of some female legs and is often referred to as cellulite. The deposits of adipose fats are reduced somewhat by disruption and wearing down due exercise causing internal friction within the hypodermis, particularly when a rubbery friction face like a TPU friction face is used that is water wetted so as to cause significant ‘stick-slip’ frictional behaviour, water behaving as an anti-lubricant. Stick-slip occurs during sliding when sliding momentarily stalls until the stress levels rise sufficiently to resume sliding, this creates a highly beneficial vibratory effect during sliding over long strokes of greater than 50 mm. Tests revealed that it might take several weeks of daily application with the tools before benefits become evident on cellulite

By way of a guide the following figures indicate average forces and areas of frictional engagement measured while treating various areas of a human body. In treating human lips, where the cutaneous layer is thin compared with the rest of the face, the reaction force R results from applying a force in the range 0.01 to 0.3N normal to a sliding interface area of between 100 and 300 mm², which is typically the area of a circular lipstick dispenser. In treating the female face, the reaction force R results from applying a force in the range 0.01 to 4.00 N normal to a sliding frictional engagement area of between 700 and 2500 mm².

In applying a shaving lubricant to a male human face, the reaction force R results from applying a force in the range 1.00 to 12.00N normal to a sliding frictional engagement area of between 850 and 1275 mm².

In treating a male neck and body the reaction force R results from applying a force in the range 1.00 to 10.00N normal to a sliding frictional engagement area of between 1000 and 5000 mm².

The range of typical contact pressures experienced development trials are calculated and shown in the following table:

| | min | max | Min | Max | min | max |
|---|---|---|---|---|---|---|
| | force | force | area | Area | pressure | pressure |
| | newtons | newtons | sq. mm | sq. mm | N/sq. mm | N/sq. mm |
| Female lips | 0.01 | 0.04 | 100 | 300 | 3.33 × 10⁻⁵ | 4 × 10⁻⁴ |
| Female face | 0.1 | 4 | 700 | 2500 | 4 × 10⁻⁵ | 5.7 × 10⁻³ |
| Female neck/body | 0.1 | 6 | 1000 | 3000 | 3.33 × 10⁻⁵ | 6 × 10⁻³ |
| Male lips | 0.01 | 0.04 | 100 | 300 | 3.33 × 10⁻⁵ | 4 × 10⁻⁴ |
| Male face | 1 | 8 | 1000 | 3000 | 3.3 × 10⁻⁴ | 8 × 10⁻³ |
| Male neck/body | 1 | 10 | 1000 | 5000 | 2 × 10⁻⁴ | 1 × 10⁻² |

The overall contact pressures at the frictionally engaged sliding interface will therefore range form 3.33×10⁻⁵ to 0.01 N/mm².

Material of the friction face should be non-aggressive to prevent it damaging the stratum corneum during sliding. The stratum corneum is the outermost layer of skin comprising of 12 to 15 layers of flat platelets of dead and dying keratin material collectively between 0.07 and 0.12 mm thick. These platelets are joined with flexible lipid material that seals the outer layer. The platelets naturally shed.

The stratum corneum may be damaged if the friction surface has abrasive materials thereon that are capable of cutting or if there are sharp scraping edges that might start to penetrate somehow. If the friction face is harder than the stratum corneum it has the potential to exfoliate, and providing it does not have sharp edges this is unlikely to cause damage providing the contact forces remain moderate. The friction should be such as to cause only very mild inflammation, barely pinking up the surface of the skin after 2 minutes rubbing.

To treat a large area using a reciprocating action, which means alternating back and forward, the tool should be progressively moved slightly sideways to traverse the areas. On the face and neck the muscles are mostly aligned vertically, running down over the forehead and across the cheeks and under the jaw and down and across the neck. The alignment around the mouth and below the nose and around the eyes becomes very complex and these tend to be laterally orientated. During rubbing with the tool the friction face should follow the muscle alignments generally be slid in the up down direction on the face except for the lower face where it can be applied in a semi-circular alternating rubbing motion. It is beneficial to rub along and across deep crease lines also.

The term cutaneous as used herein describes skin, an organ of a mammalian body and matters relating thereto, existing on, or affecting the skin. A cutaneous reaction means in relation to this invention, an increase in metabulisum, lymphatic or vascular activity such as blood supply to the dermis due to exercise the result of deformation and/or sliding contact with a tool.

The term subcutaneous as used herein describes a layer of soft tissues immediately under and supporting and coupled to the cutaneous layer. A subcutaneous reaction is understood to mean, in relation to this invention, the effect of stresses, deformation and exercise of the hypodermis (that part of the subcutaneous layer immediately under the dermis) and muscle and connective tissue associated therewith.

### BRIEF DESCRIPTION OF THE DRAWINGS

There are now described several embodiments of the invention, with reference to the accompanying drawings.

FIG. 1 is a schematic illustration in cross section of a tool frictionally engaged with skin, with a vectored force applied thereto to exercise said skin laterally.

FIG. 2 illustrates magnified a cross-section view of skin with hairs frictionally engaged with a non-aggressive fibre friction pad.

FIG. 3 illustrates a friction pad on a support with friction face frictionally engaged with skin, the stressed skin stressing a subcutaneous muscle.

FIG. 4 illustrates by way of an example a tool being used to exercise facial tissues while applying shaving lubricant or after shave moisturiser.

FIG. 5 illustrates by way of an example a bladed tool being used to exercises cutaneous and subcutaneous tissue for anti-cellulite treatment.

FIG. 6 illustrates by way of an example a stick tool for implementing the method in which detachable first bodies are impregnated with a compound.

FIG. 7 illustrates by way of an example a tool with fluid storage and dispensing means for implementing the method.

FIG. 8 illustrates by way of example a powered tool with supporting friction faces that limit the area over which the skin is stretched.

FIGS. 9A to 9D are schematic illustrations in cross section of alternative tools herein when frictionally engaged with skin, with a vectored force applied thereto to exercise said skin laterally.

FIGS. 10 and 11 show perspective view of alternative tools herein that are held by the hand of a user.

### DETAILED DESCRIPTION OF THE DRAWINGS

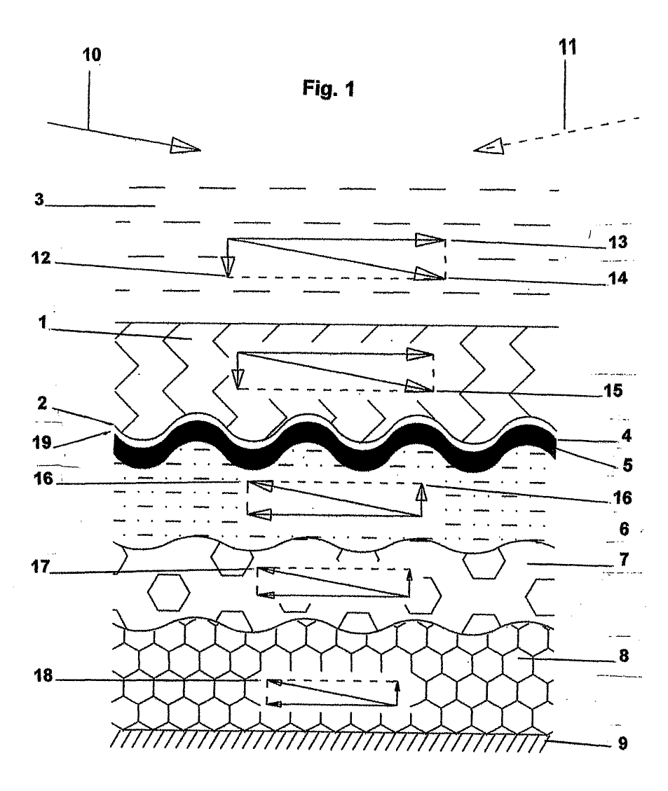

FIG. 1 is a schematic diagram in cross section view (and not to scale), showing a friction pad layer 1 carrying friction face 2, the friction pad 1 mounted on a support layer 3. In different aspects, the friction pad 1 comprises (A) a lofty non-woven fibre material; or both a compressible foam layer and a layer of friction-enhancing material defining a friction face. The friction face 2 placed in sliding frictional contact with the outer layer of mammalian skin 4, so as to evenly grip the skin and laterally displace the outer cutaneous layers 5 and 6 and thereby exercise the subcutaneous layers 7 and 8 against a base anchorage 9; the forces are described by reference to vectors shown inserted on the relevant layers.

Vectors 14, and 15 show the applied forces and 16, 17 and 18 show the reaction forces, illustrating how the applied energy is dissipated when doing work within and between the layers within the diagram as externally applied forces 10 and 11 alternate. The external forces 10 and 11 are applied to the support layer 3 by means of holding the tool that is not shown.

The friction pad 1 is resiliently deformable and is preferably slightly less deformable than the outer layer of the skin the stratum corneum 4, which is a thin virtually lifeless outer layer on the epidermis 5 that acts as the skins main water-proofing seal. The dermis 6 is a flexibly deformable layer with some resilience, is visco-elastic and is the tough and fibrous and provides most of the skins mechanical strength and elasticity. A further layer under the dermis 6 is known as the hypodermis 7, which is a visco-elastic soft and spongy fibrous tissue with adipose deposits and vascular services that feed and support the living tissue in the dermis 6 but is mechanically less strong than the dermis 6. The last layer the basal region 8 comprises further adipose tissues (layers of insulating fat), connective tissue and muscles. These layers are anchored to the skeletal frame 9 by connective tissue and secure retain the skin in position over the body.

The friction face 2 is shown with sinusoidal roughness for illustrative purposes; the actual roughness of skin and friction face are random and non aggressive. In use as the friction face 2 is placed against the outer layer of the skin the stratum corneum 4 it frictionally engages, shown schematically as sinusoidal interlocks that resist sliding. There is a gap 19 shown between the friction face 2 and stratum corneum 4 for a friction modifying fluid film.

Force vectors 10 and 11 are alternately applied to the support layer 3. Vector 14 wherein it resolves into a vertical component 12 and a lateral (horizontal) component 13. Vector 14 within the support 3 corresponds in magnitude and direction to externally applied vector 10. Vector 15 in the friction pad 1 is shown slightly smaller but in same direction 14, the reduction in size reflects frictional loss and material hysteresis within friction pad layer 1. Owing to the highly uniform frictional engagement between friction face 2 and the cutaneous layers 4, 5 and 6 the vector force transfers across into the dermis 4 and vector 16 illustrates the reaction force of the cutaneous and subcutaneous tissues (layers), the reaction force being equal and opposite the applied force less internal frictional loss and hysteresis in the reacting layers.

Joined subcutaneous layers 7 and 8 are relatively spongy and soft and held bonded to the skeletal frame 9. The tissues in these layers react with vector forces 16, 17 and 18 against applied vector force 15, each reaction vector resolving with a vertical and lateral component. The final reaction vector force 18 is shown smallest because of the accumulated internal friction losses within the preceding layers; the remaining energy is dissipated in exercising the subcutaneous tissues within layer 8.

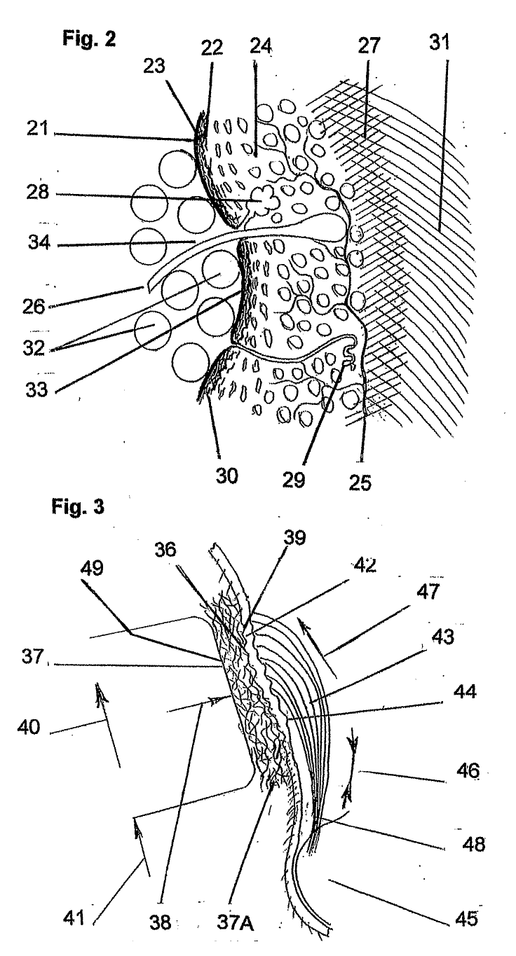

FIG. 2 illustrates a simplified cross section view of mammalian skin with hair 26 mechanically and therefore frictionally engaging with laterally orientated fibres 32; and cutaneous layers 22, 23 and 24, and subcutaneous layers 27 and 31 being exercised, shown approximately to scale. Friction face fibres 32 are shown pressing against face 33, this deforms the skin inwards at 33 to form an interlock that resists lateral sliding. The hair 26 is shown surrounded by fibres 32 in region 34 so the hair 26 is interlocked about region 34 and resists sliding. Finally, there will be molecular attractions between the materials of the friction fibres 32 otherwise referred to as friction elements where they touch the skin and these attractions also resist sliding.

The stratum corneum 21 is the outer horny surface of the epidermis 22, which is the outermost layer of the skin. The epidermis 22 is between 0.07 and 0.12 mm thick and consists of up to 15 layers of flat platelets of dead or dying cells of keratin 23, joined with a flexible lipid (too small to be discernable on a drawing of this scale). During rubbing with fibres 32 loose platelets are removed. Lipids act like flexible glue like seals holding the keratin platelets together and creating an elastic barrier layer that keeps out dirt and unwanted fluids and protects the dermis 24, the living part of the skin.

The dermis 24, is a fibrous leathery mass typically about 1 mm thick in older skin but up to 2 mm thick in young skin. The dermis 24 consisting mainly of fibrous collagen, a protein that comprises 70 to 80% of the dry weight of the skin and gives the dermis 24 its mechanical and structural strength. Collagen is relatively inelastic. Elastin makes up the balance and provides the skin with its elastic properties. Elastin fibres can extend 50% and recover without permanent elongation, combined these give skin visco-elastic properties.

FIG. 3 illustrates the tool being used on a simplified cross section through tissues in which there is a single muscle 43 linking the hypodermis 44 to a bone 45. The diagram shows a friction face 36 on a friction pad 37, in turn supported by planar support surface 49. The friction pad 37 with friction face 36 thereon is pressed against skin (equivalent to first vector component force 12 in FIG. 1), in direction of arrow 38 to form a frictional engagement at interface 39. An external lateral force 41 (equivalent to second vector component force 13 in FIG. 1) is then applied to slide the friction face in the direction of arrow 40 that is parallel (lateral) with the skin.

The frictional interface 39 is shown wavy (sinusoidal as in FIG. 1) to represent the rough face of the friction face 36 deforming the skin 42 and thereby forming many wavy high friction interlocks between the friction face 39 and deforming skin 42. Friction pad 37 extends beyond the planar support 49 at the edge 37A providing a soft edge to minimise stress transitions in the skin during sliding.

If the muscle 43 is in compression (internally tensed) in the direction of arrows 46 and an external tensile stress is applied by the sliding motion of friction face 36 in direction 47, muscle 43 is stretched in the direction of arrow 47. The stretching exercises the muscle, reacting via the tendon 48 that is firmly anchored to the bone 45, this is known as resistance exercise.

FIG. 4 illustrate how a friction tool 82 is used to apply a lotion, such as a shaving lubricant to the lower face by stroking in directions 51, 52, 53, 54 and 55. Arrows 81 on the upper face illustrates how other cosmetic treatments are applied to the entire face and exercises virtually all the subcutaneous facial muscles while applying a cosmetic lotion with a friction tool.

The shaving lubricant is applied with the friction face 50 on friction tool 82 that is used to slide and rub along the general alignment of the major muscles of the face 51, 52, 53, 54, 55. The friction tool mechanically engages with the hairs as illustrated in FIG. 2 and lifts them by pushing and pulling and thereby also stretches and compresses the skin and the muscles attached thereto as illustrated in FIG. 3 and exercise the muscles. Friction tool 82 is here shown applying lubricant, such as shaving lather to the chin by sliding in the up/down direction shown by arrow 51. Arrow 52 shows the direction of sliding for the side burns. Arrow 53 shows the direction for treating the cheeks and 54 around the mouth. Arrow 55 shows the motion under the chin and down the neck. Because there are many overlaying minor expressive muscles around the lower part of the face, and these are orientated in various directions, this part of the face may be rubbed in more lateral directions with the tool 82 providing on average the direction of each stroke is reciprocated (alternated). All the facial muscles benefit from the exercise because, they are mainly joined direct to the skin and can be seen bulging through the skin, which influences face shape and appearance.

Referring back to FIG. 2, this shows the hair 26 actually reaches through the cutaneous layers 22, 23, 24 down to the subcutaneous layer 27. Thus the deformation forces when sliding against hair growth in FIG. 4 tends to be transmitted via the hair follicles straight into the subcutaneous layer 27, 31 and there is less deformation in the cutaneous layer 22, 23, 24 than might be expected and this provides very beneficial subcutaneous exercise. In FIG. 4, the more vigorous the sliding and the more extensive the area treated the greater the improvement in appearance. The face shows improvement because the subcutaneous expressive muscles are expanded, giving the appearance of lifted cheeks, reduced deep crevices and reduced neck flab and firmer tighter skin overall. These effects start to be noticed after the first few shaves, thereafter a steady improvement occurs up to between fifteen and twenty shaves, after which the muscles are maintained in an exercised state providing the process is repeated at least every other day.

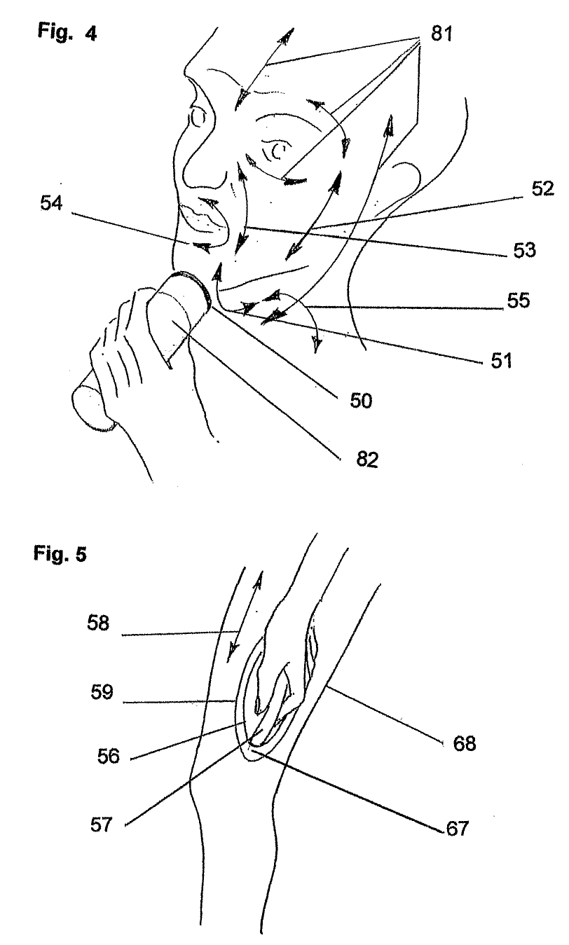

It was found beneficial to treat the entire face including the forehead, the nose and around the eye sockets with a blade like tool, similar to but approximately half the size of the that illustrated in FIGS. 5, 56, 57, 59. This tool is highly conformal and readily follows the curvature of the face, and reaches into recessed areas. This tool was used to treat a female face, used to slide along the arrow directions 51, 52, 53, 54, 55 as well as the additional arrows 81 to fully treat the entire face.

FIG. 5 by way of a further example illustrates a similar method of treatment for exercising subcutaneous tissue applied to a female leg 68 with a large area-blade like tool with handle 57 coupled to a stiff support 56 carrying a friction pad 67, the rubbing friction face 59 projecting beyond the support 56 to give the tool a soft edge and thereby minimise shear stress in the skin near the tool edge during sliding. The tool is shaped rather like that on a plasterers trowel and is used to slide in alternating directions as shown with arrow 58. The tool blade 56 must be stiff in at least one axis preferably along the axis of the handle 57 to allow sufficient contact pressure to be applied. The blade tool may carry a second face for rubbing on its reverse side. The friction face material 59 may be non-woven fibre, or a foam friction face or a composite friction face with a thin film covering a rough friction face made with foam. The support face 56 is generally flat and may as an alternative carry a special friction face in the form of an embossed thermoformed structure coupled directly thereto, the thermoformed structure carrying a lotion for slow release during sliding. A high friction rubbery material was found particularly useful for treating subcutaneous adipose tissues that tend to collect at the back of female legs 68. If a rubbery polyurethane (TPU) friction face is used then formulations that are predominantly water provided a vigorous stick/slip action that vibrates deep into the adipose deposits.

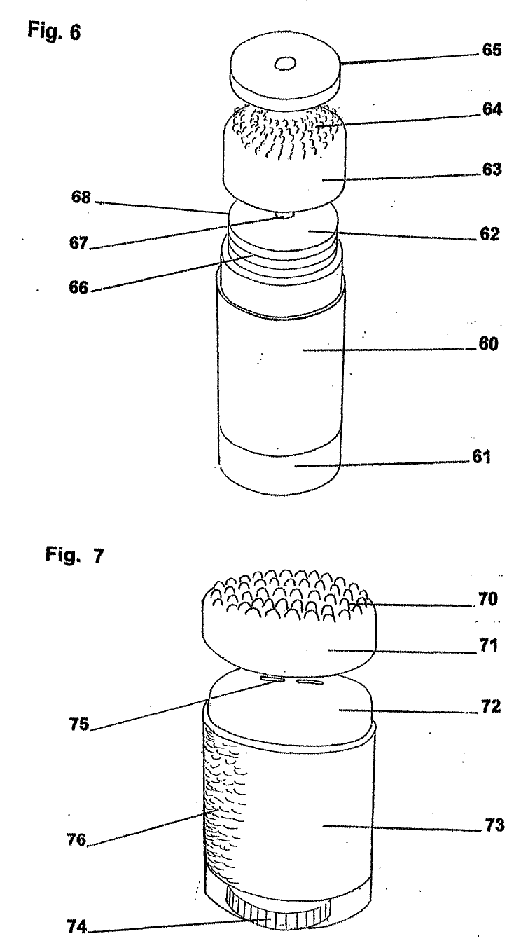

FIG. 6 illustrates a tool for implementing the method in which a container 60 is sized and shaped for gripping by hand, roughly 35 mm diameter and 100 mm long, in this tool the container lid 63 that constitutes a support onto which the friction pad is attached.

A tubular plastic holder 60, described as a propel/repel stick holder and based on a design used for deodorant sticks is used. The moulding may be round as shown 60 or it may be oblong or elliptical or any other practical mouldable shape. The moulding has a rotary knob 61 coupled to an internal screw (not shown) and upon turning 61 the contents stored within the tool body 60 are forced upwards. A column of pads 61, each of which in use serves as a friction pad, made with an absorbent material such as foam, non-woven fibres in a form ranging from a thin paper wipe to a thick lofty non-woven polymeric web and each with friction faces 62 thereon. Each pad, and therefore each friction pad may have two faces that can be used as a friction face and the density of these faces may differ to provide an optional soft or stiff friction face. Also the actual materials used in a column of pads (bodies) stored within the same holder may be varied for purposes of delivering a sequence of treatments, perhaps starting with a soft friction face working up to a more aggressive face as the skin becomes accustomed to the process. These pads are placed in the holder 60, usually laid one upon the other unsecured so as to be easily lifted off, but may optionally be interlinked with ties or adhesives run down the central screw hole 67. Separators 66 made with plastic sheet may be placed between the bodies to minimise contamination and internal flow through the stacked column 68 in storage. The bodies may be stored dry or pre-impregnated with a compound such as shaving lubricant, for example either a gel or soap. A cap 63 has means of attaching a friction pad, such means may be a contact adhesive or preferably an array of hooks 64 that engage with loops of fibre within a body 65.

The method for using the tool is to remove the cap 63 from the body 60, turn knob 61 to expose a new body 62, invert cap 63 and press the array of hooks 64 against the new friction pad 62 to engage it. Replace the cap 63 onto the body 60 with new friction pad 65 on top of the cap. The tool may then be used as shown in preceding example FIG. 4.

When the first bodies are not impregnated the shaving soap is either applied by dipping the tool with friction pad attached into a soap tub, or a shaving lubricant is somehow dispensed onto the friction face prior to use. Alternatively and most conveniently the first bodies 62 are impregnated with lubricant and an optional separation disc 66 is placed between impregnated discs to allow them to be easily separated as they are dispensed. The soap in the friction pad 65 should be soft enough to allow the hooks 64 to penetrate.

FIG. 7 illustrates a further example of a tool for implementing the method, the tool having a more rugged long life friction face 70 moulded into or mounted onto the cap 71. The friction face shown is an example of an array of protrusions either moulded or thermoformed from flat a sheet of thermoplastic material. The protrusions preferably need to be deformable so they can form a frictional engagement with skin when sliding without causing discomfort. The thermoformed protrusions are shaped to be cleaned by rinsing after use to prevent entrapment of biological contaminants.

The tool comprises a cover 72, covering a fluid storage cavity within body 73 and a cap 71 with a friction pad with a friction face 70 thereon. In use the cap 71 with friction pad 70 thereon is removable from the support 72 and fluid such as for example a shower gel or shaving lubricant is dispensed from orifices 75 in cover 72 onto a friction face 70 by turning knob 74 to force the fluid out of slots 75. The friction pad 70 on cap 71 is then slid down over support (cover) 72 and retained; the tool is used to vigorously rub against the skin, generally as described in the earlier examples and with reference to FIG. 4. For other applications such as shaving legs or applying shower gels or other cleaning and conditioning treatments, the outside areas 76 on the tool body 73, which is used primarily as a holding area, may also be partly or fully covered with a friction surface 76 and these are useful for applying treatments to large areas of skin such as legs. When friction areas on the container walls 76 are also used as rubbing faces then for practical purposes fluid must be dispensed form orifices 75 directly onto the skin. The friction face must be cleanable by rinsing of hygiene purposes.

An alternative arrangement is to incorporate the dispenser orifice 75 into the friction pad 71 either adjacent to or within the friction face 70, but this requires a one way valve be used at the orifice to prevent contamination from the friction face 70 entering the storage cavity during rubbing with friction face 70. In such an arrangement the holdable body 73 acts as the support.

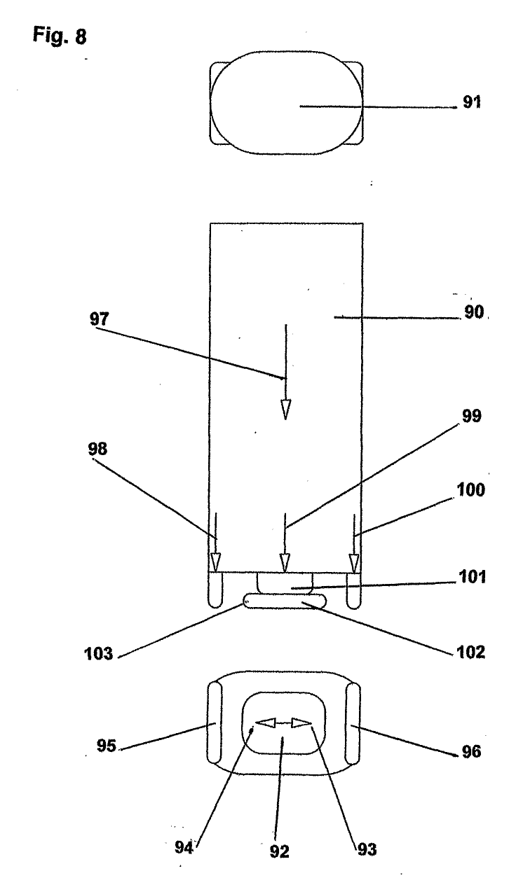

FIG. 8 illustrates a motorised vibrator with a tubular casing 90, 91 sized and shaped to be hand holdable. The aim of this tool is to exercise subcutaneous tissue with a friction face 92 that grips but does not slide against the skin, which is beneficial when treating subcutaneous tissue under areas with very thin skin, such as lips and delicate skin under the eyes. The casing 90, 91 houses a small motor or vibrator (not shown) that couples to a second body 101 upon which is positioned a friction pad, a first body 102, which friction pad is resiliently deformable, and which friction pad 102 defines a planar friction face 92, supported by support 101 that is smaller than the friction pad 92, thereby giving the friction pad 102 and friction face 92 a soft overhanging edge 103.

In use the friction face 92 alternates in the direction 93 in the first half cycle and 94 in the second half cycle. The alternating friction pad 102 with friction face 92 thereon is positioned between two static pads 95 and 96 that are fixed to the case 90. The distance of travel of 93, 94 is equal and opposite and is preferably adjustable. In use, case 90 is positioned normal to the skin surface and pressed against the skin to position the friction face 92 on the friction pad 102 against the skin with a first force 97, which first force divides between friction face 92 and pads 95, 96. As the friction pad with first face 92 thereon alternates between pads 95 and 96 the skin is sequentially stretched and compressed against the two static pads 95, 96 and the cutaneous and subcutaneous tissues under 92 and between 95, 96 are exercised as illustrated in FIG. 1. The edges of support pads 95, 96 and friction pad 102 and friction face 92 are shaped with a radius 103 to minimise shear stress transitions within the skin as directions of the applied stresses 93, 94 alternate. The friction pad and friction face materials may be any of those described herein before, but the most practical have been found to be a foam of rubbery plastic composition either moulded to shape or in the form of a thin film stretched over a foam body. The tool can equally be configured with another shape of friction face such as for example a static pad forming a ring that surrounds a circular alternating friction pad.

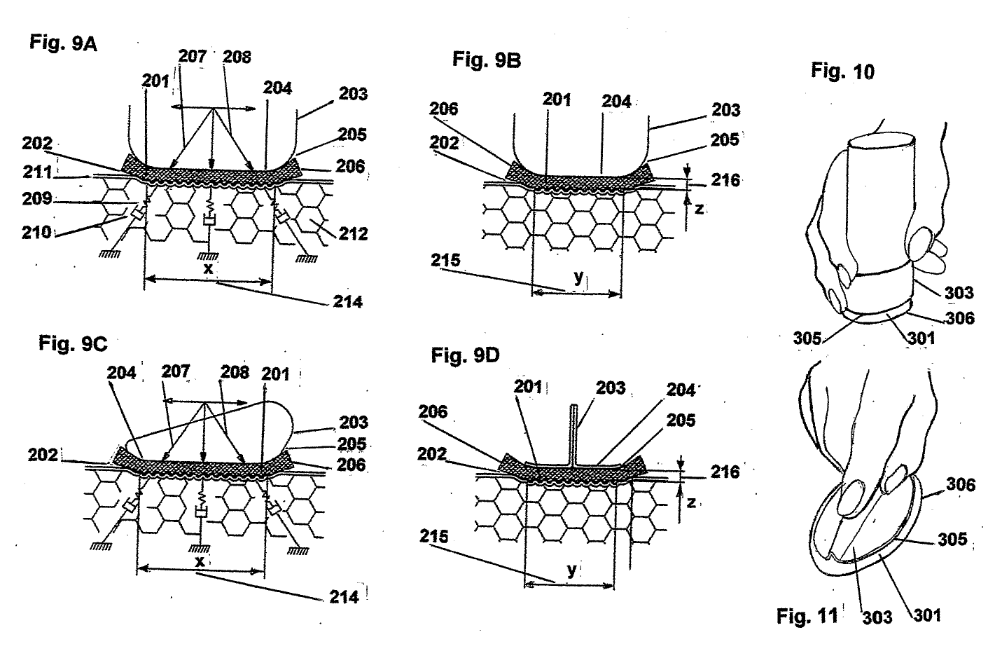

FIGS. 9 and 10 illustrate two distinct variants of the tool with similar functions.

FIGS. 9A and B are schematic cross section diagrams, FIG. 9A shows a side view of a stick like tool with an elliptically shaped friction face and FIG. 9B shows the end view of the same tool. FIG. 10 shows how this tool is held.

FIG. 9C is a side view of a blade like tool with an elliptically shaped friction face. FIG. 9D shows the end view of this tool, FIG. 11 shows how this tool is held in use.

FIGS. 9A to 9D show tools sliding over skin to exercise subcutaneous tissue. In each case, the tool is provided with a friction pad 201 with friction face 202 thereon for rubbing, and a support 203 upon which the friction pad 201 is mounted, the support 203 provided with means of holding the tool. The friction pad 201 and support 202 are arranged to support friction face 203. In different aspects, the friction pad 201 comprises (A) a lofty non-woven fibre material; or both a compressible foam layer and a layer of friction-enhancing material defining a friction face. The contact area with an ‘x’ dimension 214 the longer axis; 215 the ‘y’ axis, the shorter axis and pad depth is 216—‘z’.

It will be noted that the shape of the support 203 of each of the tool variants of FIGS. 9A and B, and 9C and D differs somewhat, but that each support 203 defines a planar support surface upon which the friction pad 202 is received. Also, bounding the planar support surface 204 the support 203 defines upwardly curving edges 205. It will be further noted that the edges 206 of the friction face 202 of the friction pad 201 project beyond the planar support face 204 and in use, tend to curl around the curving edges 305 of the support 203 to provide soft edges thereto.

The mode of use of the tool variants of FIGS. 9A and 9C is to stroke generally in the direction of the longer axis of the friction face shown as the ‘x’ dimension 214, the length of stroke should generally not exceed the length of the longer axis of the tool, and preferably (when treating the neck) with stroke lengths should be less than three quarters (75%) ‘x’ dimension 214, and most preferably when treating the face the stroke length is less than half (50%) the ‘x’ dimension 214 to minimise edge transitions during rubbing. The force vectors 207 and 208 are essentially as earlier described, particularly in relation to FIG. 1. Additionally the force vectors 207 and 208, which operate similar to those of FIG. 1, are shown schematically aligned with springs 209 and dashpots 210 to indicate visco-elastic behaviour (of Maxwell materials as described earlier herein) in the cutaneous layer 211 and in particular the subcutaneous layer 212 shown schematically as a large honeycomb.

FIG. 10 shows a variant of the ‘stick’ form tool of FIG. 4 and FIG. 11 shows a variant of the blade-like tool of FIG. 5. In both cases, the friction pads 301 of the tools of FIGS. 10 and 11 have edges 306 of the friction face (not visible) of the friction pad 301 that project beyond the planar support face (not visible) and that in use, tend to curl around the edges 305 of the support 303 to provide soft edges thereto. The tools in FIGS. 10 and 11 are gripped to facilitate stroking along the longer ‘x’ axis of the friction pads 301.

### Example of the Method for Face Shaving and Grooming.

Half a 68 year old male's face was shaved every other day for 30 days using the frictional engagement method while applying lubricant as described hereinbefore. The other half of the face was lubricated with finger applied foam by lightly rubbing. The unshaved areas of the half of the face shaved with the method, that is the forehead and around and below the eyes as well as the shaved area was then treated with a moisturiser applied with a blade tool using frictionally engaged rubbing as described variously hereinbefore.

The area of the face to be shaved was wetted with warm water. Using a tool as illustrated in FIG. 6, a foaming shaving gel was applied to the non-woven fibre friction face of a tool and vigorously rubbing against the face as illustrated in FIG. 4 to exercise the skin on half the beard with alternating sliding strokes for about 30 seconds to create a full lather. The same gel was applied to the other half of the face by finger in the recommended way and the face was shaved, the entire face shave taking about three minutes in total.

After shaving the method was repeated by applying a moisturising lotion with a friction faced tool no the half of the face previously shaved after wetting with the high friction tool. The moisturiser applied using a small trowel like blade about on third of the size of that illustrated in FIG. 5 with a friction face having a soft foam layer 1.9 mm deep covered with a 50 micron layer of TPU film. The skin was exercised with the blade for about 1 minute. The moisturiser was applied to the other half of the face by finger.

### Results.

After five shaves the half of the face subjected to the friction method appeared fuller, tighter with reduced chin flab—assessed by pinching matching areas on opposite sides of the face simultaneously, the loose flabby tissue reducing so that pinched volumes reduced by 40% after five applications of the method. After five shaves, the depth of skin creases around the mouth and chin appeared to have reduced by between 20 and 40% in depth and the skin over the cheeks showed less wrinkles.

After 15 shaves the process stabilised and the improvements were maintained. The stiffness of the skin in the cheek below the eye bags appeared greater on the treated side and did not wrinkle as readily. The part of the face subjected to the method remaining noticeably more muscular and the fleshy part of the cheek appeared lifted upwards towards the eye. The expanded muscles of the cheek were felt within the mouth and there was a general improvement in appearance down the jaw line and neck, where a pinch test showed significantly less flab (estimated at 80%).

The moisturiser used to treat the unshaven areas did not use so called active anti-wrinkle ingredients. After 15 applications an independent beautician commented that the frown lines were slightly reduced, the eye region was less wrinkled and the skin pours appeared finer.

After 60 days (30 shaves) the side shaved showed no sign of soreness or skin irritation as a result of using the method.

It was noticed that over the period of the trial the jaw bone became tighter within its socket when chewing.

The tests were repeated on a 38 year old male face with similar results.

### CONCLUSION

As the exercised facial muscles become stronger, they shorten and flatten due to hypotrophy, causing nearby skin to appear firmer and a better fit to the skeletal frame of the face, thus improving the shape and the appearance of the face and reducing wrinkling. Exercise also appears to thickened the skin slightly by raising fluid levels and improves its reflective colouring through the slightly translucent epidermis by improving the alignment near surface collagen fibres, all of these features combine to give a generally healthy appearance. The physical exercise is said to improve vascular function. It was noticed in older faces there was a reduction of visible capillary veins at the surface. Also according to the literature, it is expected that regular exercise improves lymph drainage thus removing bodily waste from the subcutaneous muscle tissues as well as cutaneous tissues. Skin pore cleanliness on the face and especially on and about the nose was noticeably improved.

Despite deliberately stretching the skin beyond its elastic limits during vigorous rubbing, the overall effect is to actually tighten the skin and increase its elastic range over a period of time by optimising the fibre distribution within the dermis and hypodermis, which is akin to training the skin and more specifically training the expressive features of the face. The increased elastic range improves facial dynamics so there is less wrinkling but greater movement (displacement of tissue) during smiling, which improves the quality (warmth) of the smile.

Finally the mechanical action of rubbing to exercise the skin as topically applied cosmetic compounds are applied is potentially highly advantageous because the friction action provides energy to activate chemical interactions, thereby offering alternative means of applying active cosmetic chemistry.

1. A friction tool for use in a cosmetic method for the treatment of mammalian skin, the tool comprising
a body;
said body defining a support having a planar support face;
a resiliently deformable friction pad provided to said support face,
said friction pad defining a friction face, wherein
the friction pad comprises a lofty non-woven fibre material.

2. A friction tool for use in a cosmetic method for the treatment of mammalian skin, the tool comprising
a body;
said body defining a support having a planar support face;
a resiliently deformable friction pad provided to said support face,
said friction pad defining a friction face, wherein
the friction pad comprises a compressible foam layer in combination with a layer of friction-enhancing material that defines said friction face.

3-24. (canceled)

25. A cosmetic method for the treatment of mammalian skin by a tool defining a friction face, the method comprising:
bringing said friction face of said tool into contact with an outer skin surface of a cutaneous layer of said mammalian skin;
applying a vector force to said tool, the vector force comprising a first vector component and a second vector component, wherein
said first vector component acts normal to said outer skin surface to hold the friction face of the tool in constant frictional contact with a defined area of the outer skin surface and to apply compressive force to one or more subcutaneous layers of the mammalian skin underlying said cutaneous layer; and
the second vector component acts parallel to the outer skin surface such as to laterally displace said defined area of the outer skin, thereby applying lateral stress to said one or more subcutaneous layers.

26-43. (canceled)
